(19) United States
(12) Patent Application Publication
(10) Pub. No.: US 2010/0332669 A1
(43) Pub. Date: Dec. 30, 2010

(54) METHOD AND APPARATUS FOR CREATING TRUSTED COMMUNICATION USING CO-EXPERIENCE DATA

(75) Inventors: Ning Yang, Beijing (CN); Kui Fei Yu, Beijing (CN); Jyri P. Salomaa, Espoo (FI); Yuan Guo, Beijing (CN)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/494,976

(22) Filed: Jun. 30, 2009

(51) Int. Cl. G06F 15/16

(52) U.S. Cl. 709/229

(57) ABSTRACT

An approach is provided for determining the level of trust among users of a social network with respect to their co-experiences from communicating with each other without violating their privacy.

### BACKGROUND

Communication networks with various methods of connectivity are now for many people becoming the primary gateway to the internet and also a major storage point for personal information. At the same time, there is growing interest in and demand for using networks to provide and maintain social contact among groups of users with some affinity or social networks, whether by family, friendship, work or some other relationship. As the use of social networks increases, protection of sensitive personal and professional information becomes more important. One main aspect of information protection concerns determining the trustworthiness of the people one communicates with and this requires collecting information about those people which on the other hand could violate their privacy. In another words, there is an inverse relationship between building trust and providing privacy whereas in order to increase one the other has to be sacrificed.

### SOME EXAMPLE EMBODIMENTS

Therefore, there is a need for efficient mechanisms for providing services for social network users to help them evaluate the trustworthiness of their contacts in the network without violating their privacy.

According to one embodiment, a method comprises initiating establishment of electronic communication between a first user and a second user, wherein the first user and the second user are members of a social network. The method also comprises determining trust level information of the second user with respect to the first user via a context query scheme or a subjective metrics scheme.

According to another embodiment, an apparatus comprising at least one processor, and at least one memory including computer program code, the at least one memory and the computer program code configured to, with the at least one processor, cause the apparatus to initiate establishment of electronic communication between a first user and a second user, wherein the first user and the second user are members of a social network. The apparatus is also caused to determine trust level information of the second user with respect to the first user via a context query scheme or a subjective metrics scheme.

According to another embodiment, a computer-readable storage medium carrying one or more sequences of one or more instructions which, when executed by one or more processors, cause an apparatus to initiate establishment of electronic communication between a first user and a second user, wherein the first user and the second user are members of a social network. The apparatus is also caused to determine trust level information of the second user with respect to the first user via a context query scheme or a subjective metrics scheme.

According to yet another embodiment, an apparatus comprises means for initiating, establishment of electronic communication between a first user and a second user, wherein the first user and the second user are members of a social network. The apparatus also comprises means for determining trust level information of the second user with respect to the first user via a context query scheme or a subjective metrics scheme.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing mechanisms for enabling social network users to determine the trustworthiness of their contacts in the network, in accordance with one embodiment;

FIG. 2 is a diagram for the definition of trust among the users of a social network, in accordance with one embodiment;

FIG. 3 is a flowchart of a process for determining trust levels among the users of a social network, in accordance with one embodiment;

FIG. 4 is a flowchart of a process for determining the trustworthiness of a user of a social network using a rule involving context query, in accordance with one embodiment;

FIG. 5 is a flowchart of a process for determining the trustworthiness of a user of a social network using a rule involving subjective metrics, in accordance with one embodiment;

FIG. 6 is a diagram showing the use of matching subjective metrics for determining the trustworthiness of a user of a social network, in accordance with one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a terminal that can be used to implement an embodiment of the invention.

### DESCRIPTION OF SOME EMBODIMENTS

A method and apparatus are provided for determining the trustworthiness of users of a social network. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

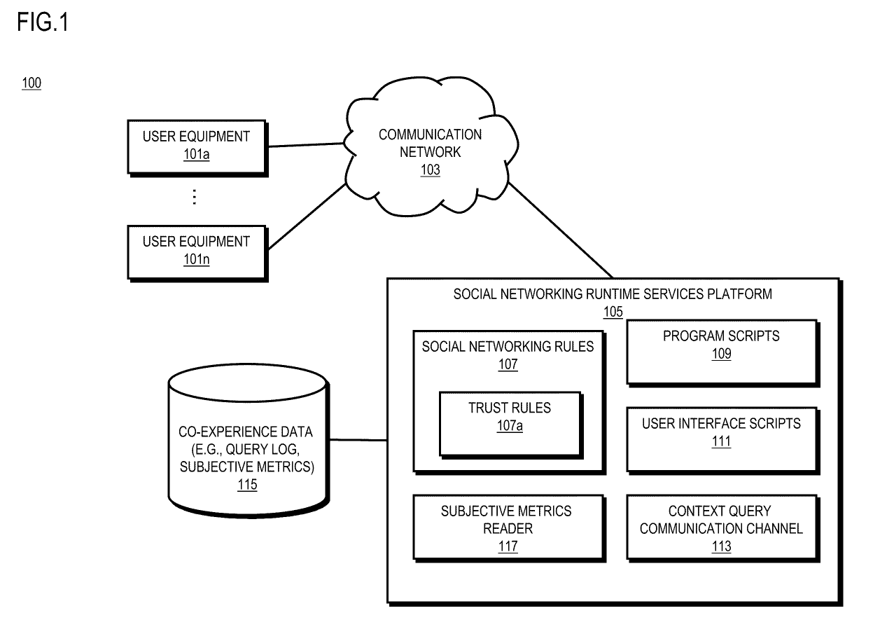

FIG. 1 is a diagram of a social network runtime capable of providing mechanisms for enabling social network user equipments to determine the trustworthiness of their contacts in the network, in accordance with one embodiment. In FIG. 1, user equipments 101a-101n communicate with each other through a communication network 103, where social networking runtime services platform 105 manages the services available to user equipments during the communication and also determines trust levels of communicating users.

As used herein, the term “trust” refers to a psychological state compromising the intention to accept vulnerability based upon positive expectation of the intention or behavior of another. Trust is a prediction (expectation) of reliance on an action, based on what a party knows about the other party. A “trusted communication system” that supports developing trust related services can improve the visibility of positive expectation so that people can make a good compromising decision during communication to maximize communication effects. Although various embodiments are described with respect to determining level of trust among users of a social network, it is contemplated that the approach described herein may be used with any type of communication system or network.

Trusted communication services are a general requirement for trusted access to people based services such as messaging, where a number of issues have surfaced whereby users have suffered losses by others disguised as friends or colleagues.

It is recognized that mobile devices as one of the rapidly developing communication channels provide people with trusted communication as the user at each end has the other end's device owner in mind. Whereas in some other communication channels such as instant messaging (e.g., Internet chat systems), the user on the other end of the communication cannot be readily authenticated. However, since trust is a psychological concept, people might distrust each other even in face to face communications. Furthermore, trust is built gradually and level of trust changes recursively during common experiences among people.

Trust issue in communication is a severe problem rooted in too little information about a caller (i.e. information publisher). Most of social networking forums/sites have mandated users to input some real information during registration. However, since users believe that other people can only see their identifications (ID) and also in order to protect their privacy, a large part of the revealed information could be unreal. One approach, known as “trust metric” technology, can be used to measure how a member of a group is trusted by the other members. The first commercial forms of trust metrics in computer software were in applications such as an on-line feedback rating, whereby users rate each other based on the on-line transactions that they are involved in with each other. An important property of trust metrics is “attack resistance” which reflects users' ability not to be overly influenced by others who try to manipulate the trust metric and who participate in bad faith (i.e., those who aim to abuse the presumption of trust). In order for this technology to be applied, more detailed information needs to be collected about the information that need to be trusted, based on the belief that some people can more easily apply their trust policies from more independent information sources. However, several issues may arise from this approach:

First issue is that this approach requires less reputation concern of information publisher and every single participant. As an example, information could be collected through a poll (voting) system, and the information publisher could ask the voters simple questions to make sure that there is a real human being is voting and not a computer. However, it is not uncommon that two analysts express totally contradictory viewpoints, and any person could use two or more IDs expressing totally different viewpoints about a topic on an Internet forum.

Secondly this approach makes every participant just meaningful in his/her voting ticket. Expression of goodwill or bad will to match positive expectation could be very hard while bad will or concealing of goodwill could be relatively easy sometimes. Therefore, the decision taken based on these expressions could be highly risky.

And thirdly, in a connected world, as assumed in trust metrics, any real information one stores somewhere in the network might be extracted and abused in another location. However, application of context for improving trust might impose a threat on privacy.

Increasing interests in Internet social networking has lead to the creation of websites such as Facebook, LinkedIn, etc., where most users are really who they claim to be in their profiles. This is the reason for LinkedIn becoming a networking tool that helps discover inside connections to recommended job candidates, industry experts and business partners. Within a community of graduated classmates, since everybody knows their classmates, a class monitor can prevent people pretending to be a classmate from joining the group. This aspect changes Internet concept for these users from a virtual world to a connected world, where they can feel the existence of people in other ends, similar to mobile communication.

This similarity with mobile communication can be summarized as “some context information is visible to trust.” That is, the communication system or other users would reveal some context information during communication. For example, the GSM (Global System for Mobile communications) SMS center would deliver caller's number to the callee, which can be presented as multimedia notification by mobile device's messaging application or other services. During a real-time call conversation, the tone of the caller's voice can be perceived. Video call service can also give visual context information. All of these can to some extent disclose more information to match positive expectations and improve trust.

However, context is not equivalent to the goodwill/bad will concept. The dilemma that could arise is that, while the incomplete context leaves space for deceit (i.e., from people behind a fake ID), fewer context should be disclosed for privacy control purposes. One example of deceit is short messages from people pretending to be relatives who urgently need money. This situation is possible because the messaging service's context data is generated by caller's SIM card (maybe from a fake caller), exchanged under offline channel (compared to connected internet channel), and presented on callee's side according to his/her phonebook item. In order to reduce the possibility of this kind of fraud, it seems video communication could create more trust. However, the video still is not fit for showing actual goodwill or bad will. Because in video communication similar to other communication systems, especially systems with rich context such as mobile communication environments, the person who discloses more context (e.g., video) offers more trust (or venerability) which might be unfair to him/her. This is the reason that technology efforts regarding trust issue in Mobile Service Architecture has been mainly concentrated on privacy control and how to define and enforce privacy policies.

To address the above issues and shortcomings, system 100 of FIG. 1 utilizes “co-experience” data to create a trusted environment. In certain embodiments, co-experience data specifies information relating a prior communication between the particular users. In a social networking environment, co-experience is the experience that users themselves create together through social interaction with each other. This data is used as a reference for determining trust levels towards other users that the user has had encounters with in the past. Previous bad communication experience would cause loss of trust in next communications and loss of trust could either cause people to become more and more silent towards someone that they have lost trust on or conceal their real thoughts and ideas from them. By way of example, the communication can include or otherwise involve a voice call, an e-mail, face-to-face communication, an instant message, short message service (SMS), multimedia messaging service (MMS), etc. The co-experience data is distributed through the social networking runtime services platform 105 to user equipments 101a-101n and is used by the equipments for determining users' trustworthiness.

According to one embodiment, the social networking runtime services platform 105 in FIG. 1 comprises components needed to manage communication among social network users through equipments 101a-101n . The social networking rules 107 are a set of regulations to be applied during the communications. The trust rules 107a is a subset of social networking rules that can be executed by a social networking runtime to set up conditions that will affect trust among network users that are behind user equipments 101a-101n. Each trust rule 107a is linked of one or more program scripts 109. The program scripts 109 is a collection of basic software that enables exchange of information between users of a social network and also defines what part of context data needs to be recorded over various communication channels through communication network 103. A trust rule 107a is also linked to one or more user interface scripts 111. The user interface scripts 111 are a collection of software codes that manages the appearance and display of information on user interfaces (i.e. cell phone or computer monitors).

The trust rules 107a contains statements that present necessary information for determining the trust level between any two users of a social network. Some examples of trust rules are as follows:

### Example Trust Rule 1: “If User1 and User2 Have Appeared in a Photo Together, When One Contacts the Other, the Photo Would Become Part of the Incoming Call Notification”

This rule means that if user1 has installed this rule on his/her mobile device and he/she has a photo taken with user2 during an event some time ago (e.g. both of them have been tagged in the photo), even though user1 may not remember the occasion but if user2 calls user1 the application of the above rule could display that photo as part of the incoming call notification on user1's mobile device.

### Example Trust Rule 2: “Automatic Extraction of Caller's Name”

This example makes use of call application and some characteristics of location/positioning applications. First characteristic is that when one person initiates a mobile originated call, the caller often knows the name of the callee. And secondly people that one communicates with most frequently are often also collocated with the caller. Therefore, if user1, user2 and user3 collocate with each other (e.g. work in the same office) and have installed the rule, and if user1 had ever made separate phone calls to user2 and user3, when user2 makes a call to user3 even though user2's name is not in user3's address book, his/her name will be displayed on user3's mobile device through social networking runtime. Virtually collocated friends (e.g. through social networking websites such as Facebook) can have their names distributed though such Internet social networking applications.

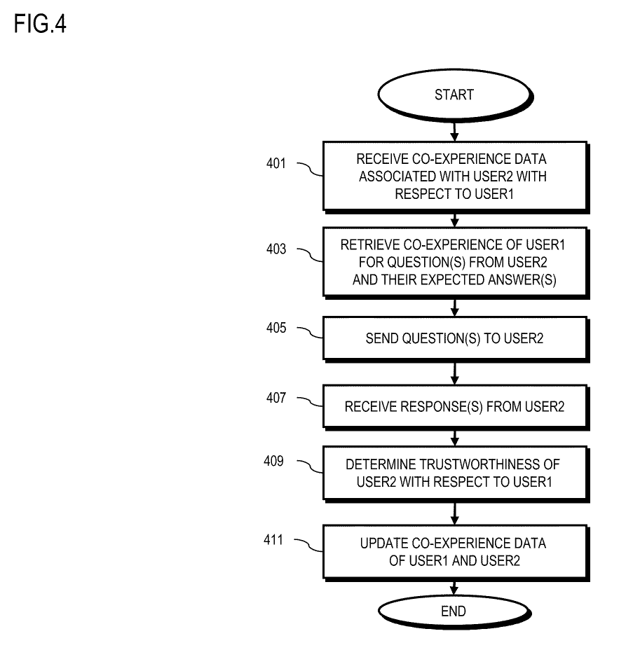

The context query communication channel 113 and the subjective metrics reader 117 are now further detailed. The context query communication channel 113 enables social network users to question each other about the co-experience data (context) from their previous communications. For example the context query communication channel 113 would extract related co-experience between a caller and a callee and create one or more queries to be imposed on the caller. The caller's responses are used for determining the trust level of callee towards caller. The detailed process of trust determination using context queries is explained in FIG. 4. The following example shows a context query:

### Example Trust Rule 3: “Who are Our Common Friends?”

It is quite often that a co-experience is witnessed by a common contact. Therefore, a query about this common contact is a typical example of a context query. The context query communication channel 113 could ask the caller: “Tell me something about your common friends with the callee so that he/she can trust you.” From the above example rule 2, a common friend can be easily selected, for example user1 could be selected as a common friend for user2 and user3. For user3 to trust a caller as being user2, a question relevant to a co-experience regarding user1 would be generated through context query communication channel 113 such as: “which side of user3's desk is user1's desk located?” The response from user2 would be used and analyzed by the context query communication channel 113 as a reference for determination of the level of trust of user3 towards user2.

The queries generated by the context query communication channel 113 could be stored in the co-experience data 115 for further use. The co-experience data 115 consists of the data generated during network users' communication and execution of program scripts 109 that make the communication possible. The co-experience data 115 include various types of data such as query logs, subjective metrics, etc. The query logs contain sample queries that a user is expected to know their responses (or answers) regarding another user together with their expected responses (answers). As explained above these queries are used by the context query communication channel 113 for determining the level of trust between users.

For people who communicate with others intensively, the relationship between one time co-experience and the positive expectation becomes causal. Human intelligence enables people to, after times and times of experience together, conclude to what extent they are cared for by other people and trust those who care for them to the expected level. At the same time people are able to develop subjective metrics (e.g. “care tank”) for themselves based on the level of their care for others.

Subjective metrics (which can conceptually be denoted as a “care tank”) determine the level of “care” of a user towards other users. Although part of these metrics could be extracted from co-experience data 115, other factors such as personal and professional benefits could affect the level of care from a user towards another.

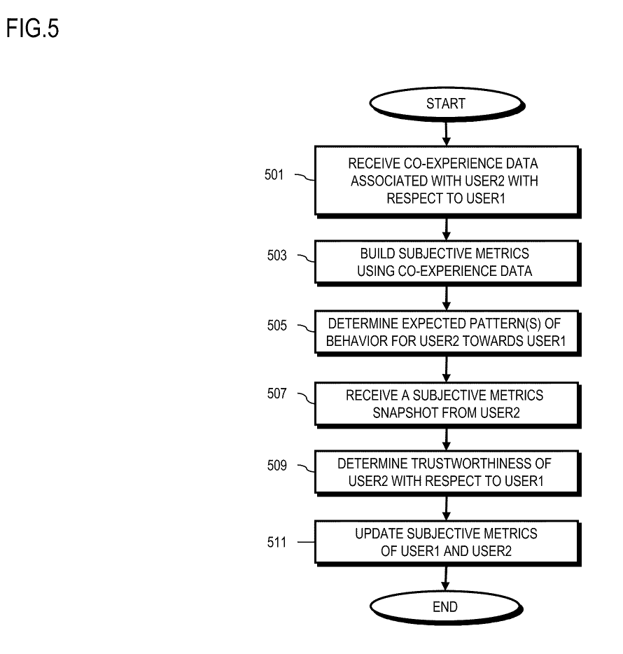

The subjective metrics reader 117 extracts snapshots of the subjective metrics of the caller regarding the callee and the callee's expected subjective metrics from the caller and compares them with each other. The result of this comparison is used for determination of trust. The detailed process of trust determination using subjective metrics is explained in FIG. 5.

In FIG. 1 the co-experience data 115 has been illustrated as a database directly linked to the social networking runtime services platform 105, however, the co-experience data could be stored in other locations throughout the system or could be distributed between various devices in different locations. For example, in one embodiment, every user equipment 101a-101n could have its own co-experience data with other equipments stored locally on the equipment. However, a distributed co-experience data provides a user with the benefit of having access to his/her co-experience data while communicating with other users through various devices (e.g. cellular phone, laptop computer, etc.).

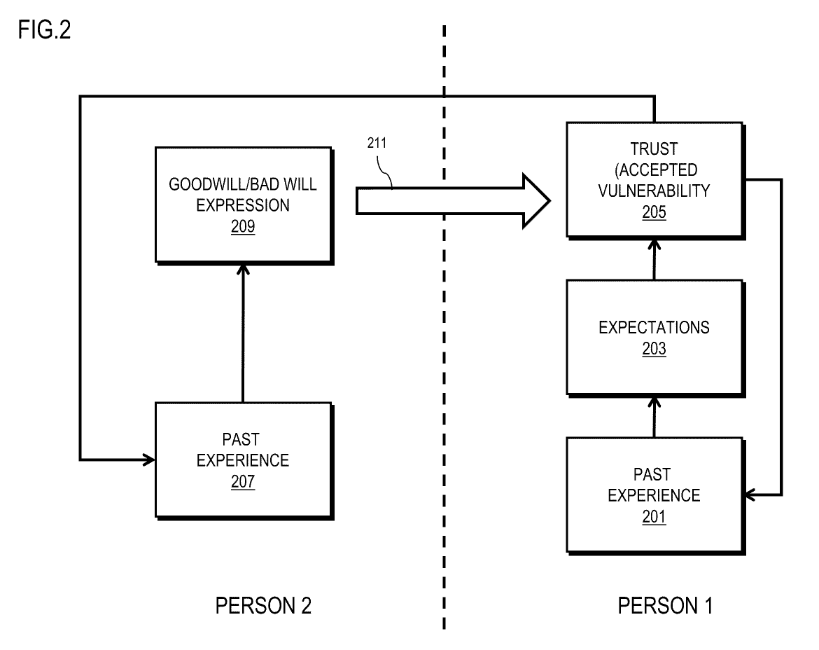

FIG. 2 is a diagram for the definition of trust among the users of a social network, in accordance with one embodiment. As seen in FIG. 2 person1 on the right hand side utilizes the information (memories) from his/her past experience 201 to create expectation 203 from person2 and based on the expectations 203 the trust or the level of accepted vulnerability 205 from person2 is determined. Previous bad communication would damage trust in future communication. However, the past experience 201 is not the only source for determination of trust. The trust is determined through comparison between expected and actual behavior. On the left side of FIG. 2 person2 has his/her own past experience information 207 based on which the expression 209 of goodwill or bad will towards person1 is shaped. And this expression is the behavior that will be revealed to person1 through channel 211 and compared against expectation 203. The result of this comparison (desirable or undesirable) will be added to past experience 201 for person1 and person1's reaction to the results will be registered by person2 in his/her past experience 207 and will affect the determination of trust in future communications.

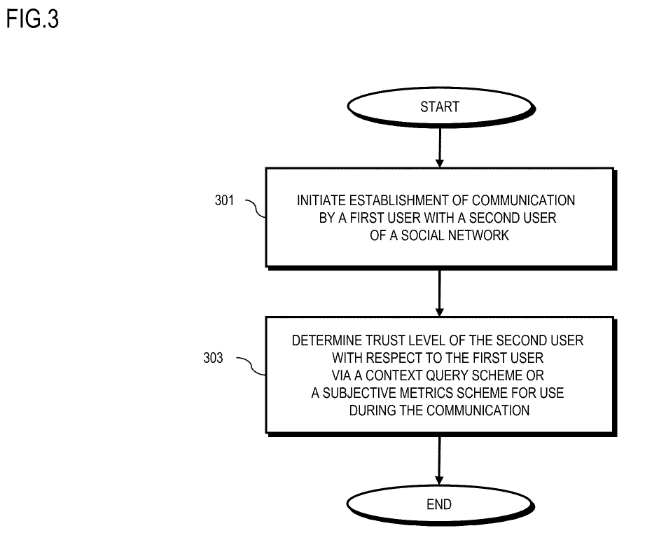

FIG. 3 is a flowchart of a process for determining trust levels among the users of a social network, in accordance with one embodiment. As per step 301 the social networking runtime services platform 105 monitors establishment of communication between users who have trust rules installed. In step 303 the social networking services runtime platform 105 executes trust rules 107a , with reference to extracted co-experience data 115, e.g. context query or subjective metrics, to determine trust level between the communicating users. The details of trust determination process including context query and subjective metrics are discussed in FIG. 4 and FIG. 5.

FIG. 4 is a flowchart of a process for determining the trustworthiness of a user of a social network using a rule involving context query, in accordance with one embodiment. Assuming that user2 is the user whose trustworthiness towards user1 is being examined, in step 401 the social networking runtime services platform 105 examines the query logs from co-experience data 115 of user1 and user2. Then per step 403 one or more questions are retrieved from co-experience data 115 to be asked from user2 and his/her expected responses.

In steps 405 and 407 the one or more questions extracted from co-experience data 115 are forwarded to user2 and his/her responses are collected. In step 409 the context query communication channel 113 compares user2's responses against the expected responses extracted from co-experience data 115. Based on the comparison results, the trustworthiness of user2 for user1 is determined. At the end of the process in step 411 the query log for user2 regarding user1 in the co-experience data 115 is updated based on the results from trust determination.

FIG. 5 is a flowchart of a process for determining the trustworthiness of a user of a social network using a rule involving subjective metrics, in accordance with one embodiment. Assuming that user2 is the person whose trustworthiness towards user1 is being examined, in step 501 the social networking runtime services platform 105 examines the co-experience data 115 of user1 and user2. Then per step 503 the subjective metrics reader 117 builds subjective metrics from co-experience data 115 related to user2 towards user1. As in step 505, the subjective metrics reader 117 uses the subjective metrics built from co-experience to draw the expected pattern(s) of behavior (e.g. care) of user2 towards user1. In step 507 the subjective metrics reader 117 receives a snapshot from the subjective metrics of user2 which shows user2's stance (e.g. level of care) towards user1. In step 509 the subjective metrics reader 117 analyzes the snapshot comparing it against the expected pattern(s) drawn in step 505. Subsequently, based on the comparison results, the trustworthiness of user2 for user1 is determined. At the end of the process in step 511 the subjective metrics of user1 and user2 in the co-experience data 115 are updated based on the results from trust determination.

The subjective metrics built from the co-experience data 115, could be conditional and the level of care of one person towards another could be measured as a relative metric. For example person A may care the most for B compared to C and D but care the least for B compared to E and F. This relative degree can then be used for matching purposes.

The above described processes of FIGS. 4 and 5 advantageously enable users to communicate more efficiently and this could result in the more efficient utilization of communication resources. That is, communication sessions between two parties that at least one of them is declared as untrustworthy could be automatically terminated, and thereby the wasteful use of the communication network resources is being prevented.

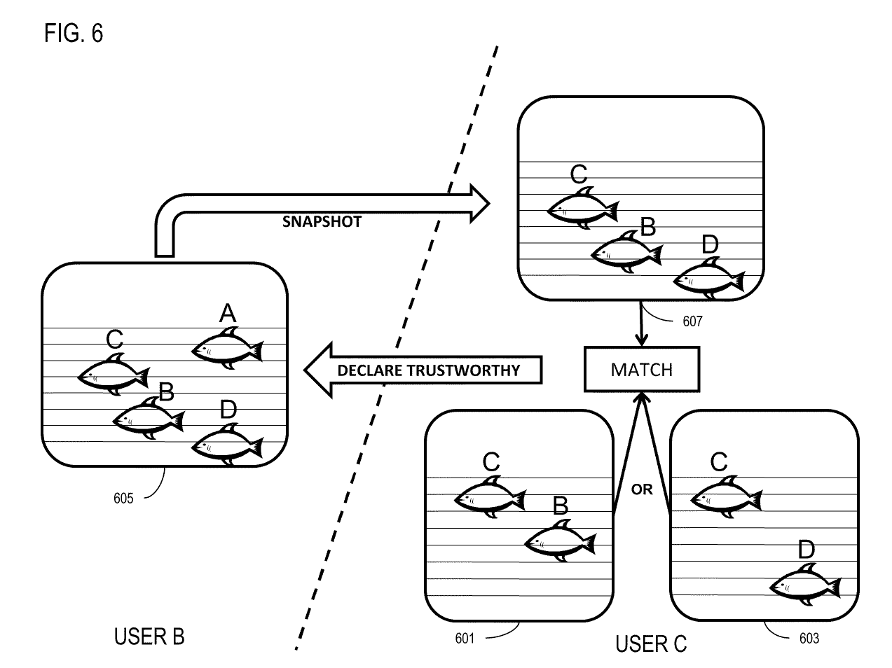

FIG. 6 is a diagram showing the use of matching subjective metrics for determining the trustworthiness of a user of a social network, in accordance with one embodiment. For the purposes of illustration, the concept of subjective metrics is shown visually as fishes in a tank. Specifically, in this diagram each fish with a label represents a user and each fish tank is the “care tank” (subjective metrics) of one user towards people close to the user. For each fish being closer to the surface means that more care is given to the corresponding person. A fish tank is quite often obscure or unclear meaning that not every person's level of received care is clear at all times. However, fish swimming on the surface and at the bottom of the tank are often visible representing that most of the time the people one cares for most and least can be easier to find compared to the ones in the middle.

As seen in FIG. 6 user C has drawn two possible expected patterns 601 and 603 for care from user B. These patterns that are drawn per step 505 of FIG. 5, can be interpreted based on the above care tank analogy as “C believes that either B cares more for C than caring for self (B) or B cares for C much more than caring for D”. Tank 605 represents the actual care tank of user B. It shows that B cares for A the most and for D the least but cares more for C than he cares for himself. And tank 607 is a snapshot from 605 drawn per step 507 of FIG. 5. The snapshot shows only the users that C would like to know about. The comparison between 601 and 603 with 607 that is conducted at step 509 of FIG. 5 shows that B's real care pattern matches with C's expectation and B cares for C more than either D or himself. Therefore, B is declared as trustworthy for C.

Since every user device has a perceived care tank snapshot from each of his/her friends, these snapshots would be used and might be modified during group communications, where vulnerability and trust issues become more complex. For example, assuming that users A, B and C are communicating and users A and B are trying to give C two totally contradicting advice. C receives snapshots from A and B's care tanks and the snapshots show that A cares more for himself than he cares for B while B's care tank snapshot shows that he cares more for A than himself. In this case C can conclude that since both A and B care more for A, the user should trust A and follow A's advice.

By adding subjective metrics and context query communication channel among people, this invention supports adding trust related rules recursively over social networking runtime to bring people a highly customized, safe and trusted communication environment.

Trust rules that do not require certain context sensors can have those sensors switched off to avoid privacy leak, while only having those sensors privately defined in program scripts to switch on to evacuate the invading/cheating space. It must be noted that the existence of co-experience helps defining the context that is used among known people. Then the user interface scripts 111 linked to trusted rules 107a could catch the occasion of trust determination based on sufficient history experience, which cannot be changed or uninstalled at that occasion, especially if the experience is among a group of people as seen in example trust rule 2.

The processes described herein for creating trusted communication using co-experience data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

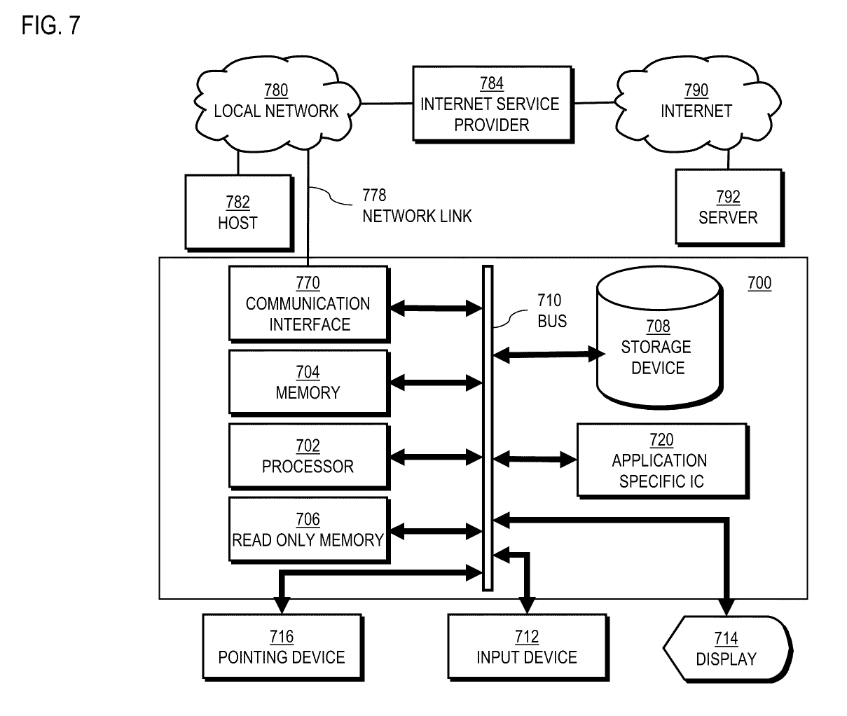

FIG. 7 illustrates a computer system 700 upon which an embodiment of the invention may be implemented. Computer system 700 includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information. The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790. A computer called a server host 792 connected to the Internet hosts a process that provides a service in response to information received over the Internet. For example, server host 792 hosts a process that provides information representing video data for presentation at display 714.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

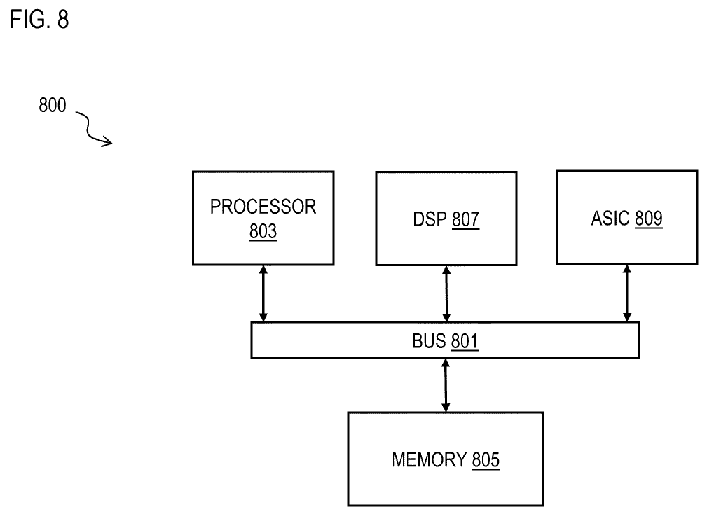

FIG. 8 illustrates a chip set 800 upon which an embodiment of the invention may be implemented. Chip set 800 is programmed to carry out the inventive functions described herein and includes, for instance, the processor and memory components described with respect to FIG. 8 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-word signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein. The memory 805 also stores the data associated with or generated by the execution of the inventive steps.

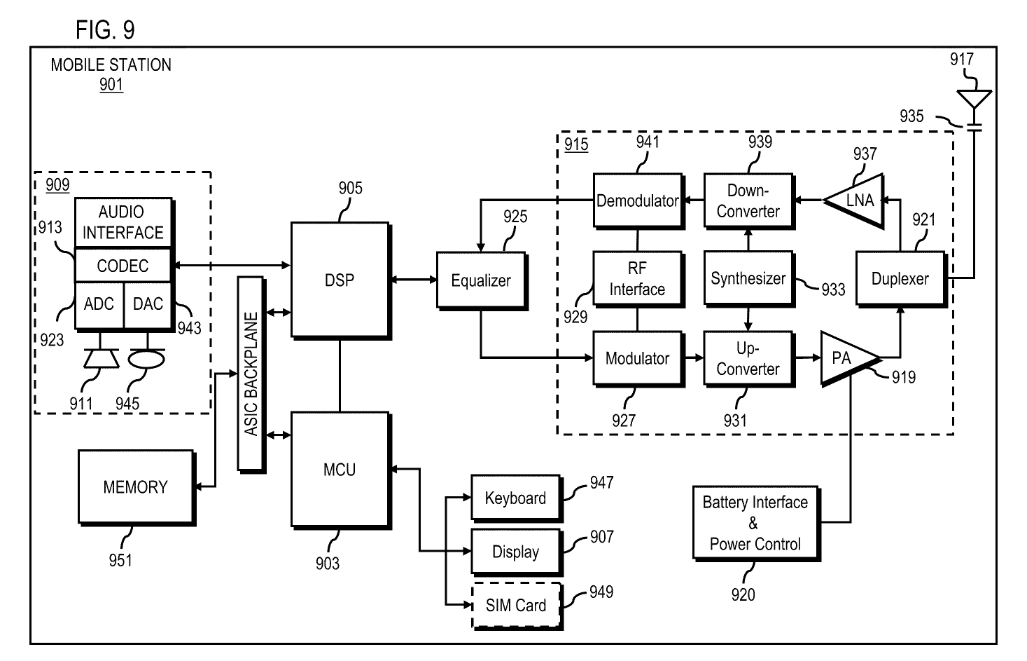

FIG. 9 is a diagram of example components of a mobile station (e.g., handset) capable of operating in the system of FIG. 1A, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the station include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In the example embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The MCU 903 delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
initiating establishment of electronic communication between a first user and a second user, wherein the first user and the second user are members of a social network; and
determining trust level information of the second user with respect to the first user via a context query scheme or a subjective metrics scheme.

2. A method of claim 1, wherein the determination of the trust level information is performed using the context query scheme, the method further comprising:
retrieving co-experience data associated with the second user, wherein the co-experience data specifies information relating a prior communication between the first user and the second user;
retrieving one or more questions and associated expected responses;
initiating transmission of the questions to the second user; and
receiving responses from the second user, wherein the trust level information is determined based on the co-experience data, the received responses and the expected responses.

3. A method of claim 2, further comprising:
updating the co-experience data.

4. A method of claim 1, wherein the context query scheme is associated with one or more trust rules.

5. A method of claim 1, wherein the determination of the trust level information is performed using the subjective metrics scheme, the method further comprising:
retrieving co-experience data associated with the second user;
building one or more subjective metrics about the second user;
determining one or more expected subjective metrics patterns for second user; and
receiving a subjective metrics snapshot from the second user, wherein the trust level information is determined based on the co-experience data, the subjective metrics snapshot and the one or more expected subjective metric patterns.

6. A method of claim 1, wherein the determined trust level information is used before or during the communication.

7. A method of claim 1, wherein the communication includes a voice call, an e-mail, an instant message, short message service (SMS), or multimedia messaging service (MMS).

8. An apparatus comprising:
at least one processor; and
at least one memory including computer program code,
the at least one memory and the computer program code configured to, with the at least one processor, cause the apparatus to perform at least the following,
initiate establishment of electronic communication between a first user and a second user, wherein the first user and the second user are members of a social network, and
determine trust level information of the second user with respect to the first user via a context query scheme or a subjective metrics scheme.

9. An apparatus of claim 8, wherein the determination of the trust level information is performed using the context query scheme, the apparatus being further caused to:
retrieve co-experience data associated with the second user, wherein the co-experience data specifies information relating a prior communication between the first user and the second user;
initiate transmission of the questions to the second user; and
receive responses from the second user, wherein the trust level information is determined based on the co-experience data, the received responses and the expected responses.

10. An apparatus of claim 9, wherein the apparatus is further caused to: update the co-experience data.

11. An apparatus of claim 8, wherein the context query scheme is associated with one or more trust rules.

12. An apparatus of claim 8, wherein the determination of the trust level information is performed using the subjective metrics scheme, the apparatus being further caused to:
retrieve co-experience data associated with the second user;
building one or more subjective metrics about the second user;
determine one or more expected subjective metrics patterns for second user; and
receive a subjective metrics snapshot from the second user, wherein the trust level information is determined based on the co-experience data, the subjective metrics snapshot and the one or more expected subjective metrics patterns.

13. An apparatus of claim 8, wherein the determined trust level information is used before or during the communication.

14. An apparatus of claim 8, wherein the communication includes a voice call, an e-mail, an instant message, short message service (SMS), or multimedia messaging service (MMS).

15. A computer-readable storage medium carrying one or more sequences of one or more instructions which, when executed by one or more processors, cause an apparatus to perform at least the following:
initiate establishment of electronic communication between a first user and a second user, wherein the first user and the second user are members of a social network; and
determine trust level information of the second user with respect to the first user via a context query scheme or a subjective metrics scheme.

16. A computer-readable storage medium of claim 15, wherein the determination of the trust level information is performed using the context query scheme, the apparatus being further caused to:
retrieve co-experience data associated with the second user, wherein the co-experience data specifies information relating a prior communication between the first user and the second user;
initiate transmission of the questions to the second user; and
receive responses from the second user, wherein the trust level information is determined based on the co-experience data, the received responses and the expected responses.

17. A computer-readable storage medium of claim 16, wherein the apparatus is further caused to:
update the co-experience data.

18. A computer-readable storage medium of claim 15, wherein the context query scheme is associated with one or more trust rules.

19. A computer-readable storage medium of claim 15, wherein the determination of the trust level information is performed using the subjective metrics scheme, wherein the apparatus is further caused to:
retrieve co-experience data associated with the second user;
build one or more subjective metrics about the second user;
determine one or more expected subjective metrics patterns for second user; and
receive a subjective metrics snapshot from the second user, wherein the trust level information is determined based on the co-experience data, the subjective metrics snapshot and the one or more expected subjective metric patterns.

20. A computer-readable storage medium of claim 19, wherein the determined trust level information is used before or during the communication.
